(19) United States
(12) Patent Application Publication
(10) Pub. No.: US 2023/0370340 A1
(43) Pub. Date: Nov. 16, 2023

(54) INTENT DEFINITION BY NETWORK ANALYTICS FOR ZERO TOUCH NETWORK MANAGEMENT

(71) Applicant: Microsoft Technology Licensing, LLC, Redmond, WA (US)

(72) Inventors: Ronald Mark PARKER, Manchester, MA (US); Michael Anthony Brown, McKinney, TX (US); Bahareh Sadeghi, Vancouver, WA (US); Mark Gordon Libby, Groton, MA (US)

(21) Appl. No.: 17/741,165

(22) Filed: May 10, 2022

(51) Int. Cl. H04L 41/5009; H04L 41/50; H04L 41/5025; H04L 41/14; H04W 24/02

(52) U.S. Cl. CPC H04L 41/5009; H04L 41/5032; H04L 41/5025; H04L 41/145; H04W 24/02

(57) ABSTRACT

Described are examples for providing intent based network configuration using a management data analytics function (MDAF) to generate lower level intents. A system of intent based network slice management includes a network management function and the MDAF. The network management function is configured to receive an original intent expectation from a higher level management function; request a lower level intent from the MDAF based on the original intent expectation; and provide the lower level intent to a lower level management function. The MDAF is configured to collect information with respect to a performance of network resources or a status of the network; identify one or more target network constituents to satisfy the original intent expectation; translate parameters of the original intent expectation to a scope of the target network constituent based on the information; and provide the lower level intent to the network management function.

### BACKGROUND

A radio access network (RAN) may provide multiple user devices with wireless access to a mobile network. The user devices may wirelessly communicate with a base station, which forwards the communications towards a core network. A core network may include multiple nodes or functions. For example, a 5G core network may include one or more Access and Mobility Management Functions (AMFs), Session Management Functions (SMFs), and a User Plane Functions (UPFs). For instance, the AMF may be a control node that processes the signaling between the UEs and the core network. Generally, the AMF provides quality of service (QoS) flow and session management. All user Internet protocol (IP) packets are transferred through the UPF. The UPF provides UE IP address allocation as well as other functions. The UPF may be connected to IP Services. The IP Services may include the Internet, an intranet, an IP Multimedia Subsystem, a packet switched (PS) Streaming Service, and/or other IP services.

A virtualized radio access network may utilize datacenters with generic computing resources for performing RAN processing for network functions. For example, instead of performing PHY and MAC layer processing locally on dedicated hardware, a virtualized radio access network may forward radio signals from the radio units to an edge datacenter for processing and similarly forward signals from the edge datacenter to the radio units for wireless transmission. As another example, core network functions may be implemented on generic cloud resources at various datacenters. Because the network datacenters utilize generic computing resources, a virtualized RAN may provide scalability and fault tolerance for network processing. Conventionally, whether using dedicated hardware or more generic computing resources, network configuration has been performed by pushing a network configuration down to lower level management functions until each network function is configured.

In complex systems, such as cellular networks in general and in cloud-based virtualized deployments specifically, variations in system resources and network conditions may increase difficulty of a human operator to understand needs of the network and provide appropriate configuration. Techniques to reduce human involvement in the network configuration process may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later

In some aspects, the techniques described herein relate to a system of intent based network slice management, including: a network management function configured to: receive an original intent expectation from a higher level management function; request a lower level intent from a management data analytics function (MDAF) based on the original intent expectation; and provide the lower level intent to a lower level management function; and the MDAF, which is configured to: collect information with respect to a performance of network resources or a status of the network; identify one or more target network constituents to satisfy the original intent expectation; translate parameters of the original intent expectation to a scope of the target network constituent based on the information; and provide the lower level intent to the network management function.

In some aspects, the techniques described herein relate to a system, wherein the MDAF is configured to monitor performance of the one or more target network constituents with respect to the lower level intent and the original intent expectation.

In some aspects, the techniques described herein relate to a system, wherein the MDAF is configured to update the lower level intent based on the performance.

In some aspects, the techniques described herein relate to a system, wherein the network management function is further configured to: receive an unsolicited intent from the MDAF; and provide the unsolicited intent to the lower level management function.

In some aspects, the techniques described herein relate to a system, wherein the information with respect to performance of network resources or the status of the network includes a metric or status of one or more of computing resources, storage resources, or transport resources.

In some aspects, the techniques described herein relate to a system, wherein to identify the one or more target network constituents to satisfy the original intent, the MDAF is configured to identify network constituents implied by parameters of the original intent.

In some aspects, the techniques described herein relate to a system, wherein to translate parameters of the original intent expectation to a scope of the target network constituent based on the information, the MDAF is configured to: set a performance target for the target network constituent based on the parameters; and estimate a parameter within the scope of the target network constituent to achieve the performance target based on the information.

In some aspects, the techniques described herein relate to a method of creating an intent based on network analytics, including: receiving, at a management data analytics function (MDAF), a request for a lower level intent based on an original intent expectation from a network management function; receiving information with respect to a performance of network resources or a status of the network; identifying one or more target network constituents to satisfy the original intent; and translating parameters of the original intent expectation to a scope of the target network constituent based on the information.

In some aspects, the techniques described herein relate to a method, further including monitoring performance of the one or more target network constituents with respect to the lower level intent and the original intent expectation.

In some aspects, the techniques described herein relate to a method, further including updating the lower level intent based on the performance.

In some aspects, the techniques described herein relate to a method, wherein the information with respect to performance of network resources or the status of the network includes a metric or status of one or more of computing resources, storage resources, or transport resources.

In some aspects, the techniques described herein relate to a method, wherein identifying one or more target network constituents to satisfy the original intent includes identify network constituents implied by parameters of the original intent.

In some aspects, the techniques described herein relate to a method, wherein translating parameters of the original intent expectation to a scope of the target network constituent based on the information, includes: setting a performance target for the target network function based on the parameters; and estimating a parameter within the scope of the target network constituent to achieve the performance target based on the information.

In some aspects, the techniques described herein relate to a method, further including, at a network management function: receiving an original intent expectation from a higher level management function; requesting the lower level intent from the MDAF based on the original intent expectation; and providing the lower level intent to a lower level management function.

In some aspects, the techniques described herein relate to a method, further including: receiving an unsolicited intent from the MDAF; and providing the unsolicited intent to the lower level management function.

In some aspects, the techniques described herein relate to a non-transitory computer-readable medium storing computer executable instructions for intent based network slice management, including instructions to: receive, at a management data analytics function (MDAF), a request for a lower level intent based on an original intent expectation from a network management function; receive information with respect to a performance of network resources or a status of the network; identify one or more target network constituents to satisfy the original intent; and translate parameters of the original intent expectation to a scope of the target network constituent based on the information.

In some aspects, the techniques described herein relate to a non-transitory computer-readable medium, further including instructions to: monitor performance of the one or more target network constituents with respect to the lower level intent and the original intent expectation; and update the lower level intent based on the performance.

In some aspects, the techniques described herein relate to a non-transitory computer-readable medium, wherein the information with respect to performance of network resources or the status of the network includes a metric or status of one or more of computing resources, storage resources, or transport resources.

In some aspects, the techniques described herein relate to a non-transitory computer-readable medium, wherein the instructions to identify one or more target network constituents to satisfy the original intent includes instructions to identify network constituents implied by parameters of the original intent.

In some aspects, the techniques described herein relate to a non-transitory computer-readable medium, wherein the instructions to translate parameters of the original intent expectation to a scope of the target network constituent based on the information, includes instructions to: set a performance target for the target network function based on the parameters; and estimate a parameter within the scope of the target network constituent to achieve the performance target based on the information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example of an architecture for network management of a virtualized cellular network, in accordance with aspects described herein.

FIG. 2 is a diagram of an example of network slice based management and analytics of a virtualized cellular network, in accordance with aspects described herein.

FIG. 3 is a diagram illustrating generation of a lower level intent to satisfy a higher level intent expectation based on network analytics, in accordance with aspects described herein.

FIG. 4 is a schematic diagram of an example of a device for intent definition by network analytics, in accordance with aspects described herein.

FIG. 5 is a flow diagram of an example of a method of configuring a network using intent definition by network analytics, in accordance with aspects described herein.

FIG. 6 is a flow diagram of an example of a method of utilizing a management data analytics function (MDAF) to generate lower level intents, in accordance with aspects described herein.

FIG. 7 is a schematic diagram of an example of a device for performing functions described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

The concept of intent driven network management allows a client to specify a specific goal (or intent target) to be satisfied within a set of specific expectations (also referred to as contexts). The server, e.g., the intent-handler or the service provider, provides the client with updates regarding the status of the intent. If the server cannot achieve the goal specified as the intent, then the server may reject the intent. If a satisfied intent is degraded and no longer fully satisfied, the server notifies the client of the degradation. The client then may choose to update the intent and set a new goal.

In complex systems, such as cellular networks in general and in cloud-based virtualized deployments specifically, the variations in system resources and network conditions may increase the difficulty for a human operator to understand how a network configuration operates. For example, 5G network management includes the concepts of network slicing and service based architecture. Artificial intelligence (AI) or machine learning (ML) analytics may provide insight into network operation, but usually includes further action by a human network operator to act on the analytics.

In an aspect, this disclosure describes various examples related to network management for virtualized cellular networks using network analytics to generate intents for lower level network management functions. For example, the network management functions may configure network functions within a 5G radio access network (RAN) and/or 5G core network. An intent-client such as a higher level network management function or network operator may provide an intent expectation to a network management function. An intent expectation may also be referred to as an intent target or intent declaration. The network management function may request a management data analytics function (MDAF) to generate one or more intents for a lower level network management function. The MDAF may have access to a wide range of information regarding a status of the network or performance of network resources. As noted above, the intent expectation may identify performance goals. The MDAF may identify one or more target network constituents to satisfy the intent expectation. The target network constituents may correspond to intents for a lower level network management function. The MDAF may translate parameters of the original intent expectation to a scope of the target network constituents to generate one or more intents for a lower level management function. The MDAF may provide the intents to the requesting network management function, which may in turn provide the intents to the lower level network management function.

In an aspect, the use of network analytics to generate intents may improve performance of network management functions and the network itself. For example, the use of network analytics may reduce the need for human input into a network configuration, thereby reducing human configuration delay and errors. For example, the configuration of network constituents may be automatically specified. Further, configuration by the network analytics may include optimization of a parameter. For example, the analytics may provide the lowest cost configuration that satisfies the higher level intent. Additionally, the network analytics may continue to monitor performance of the network with respect to an intent and update the intent if needed.

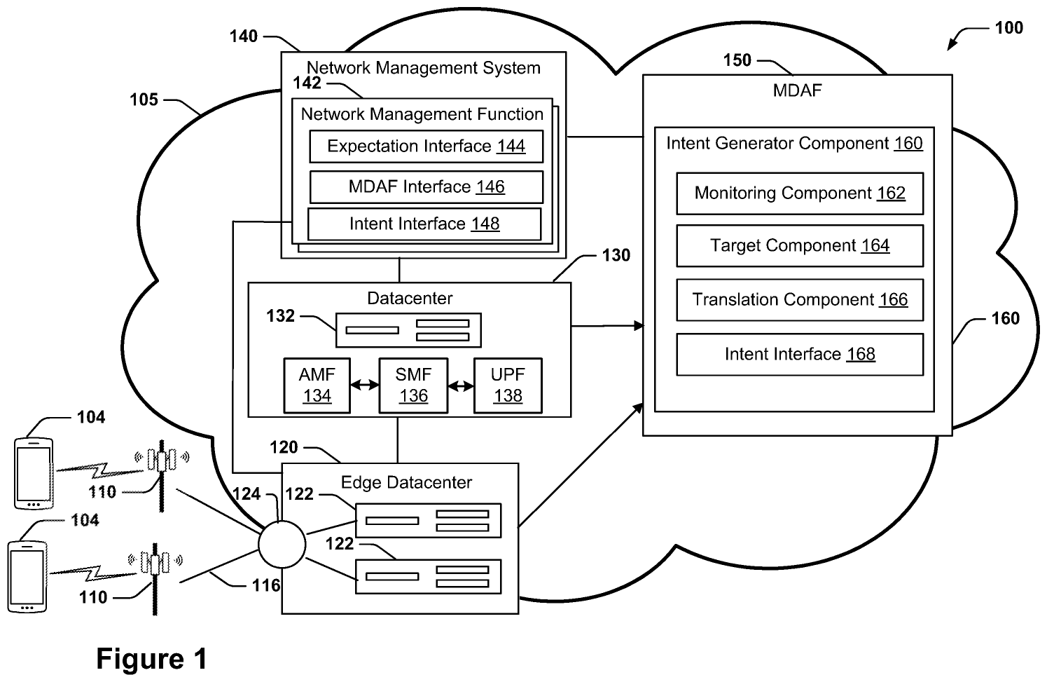

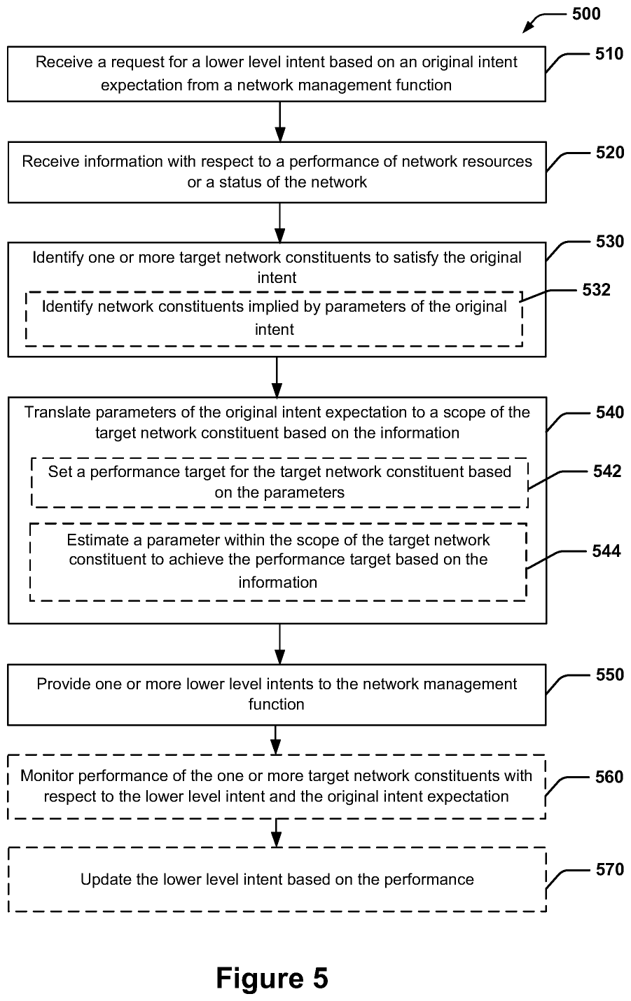

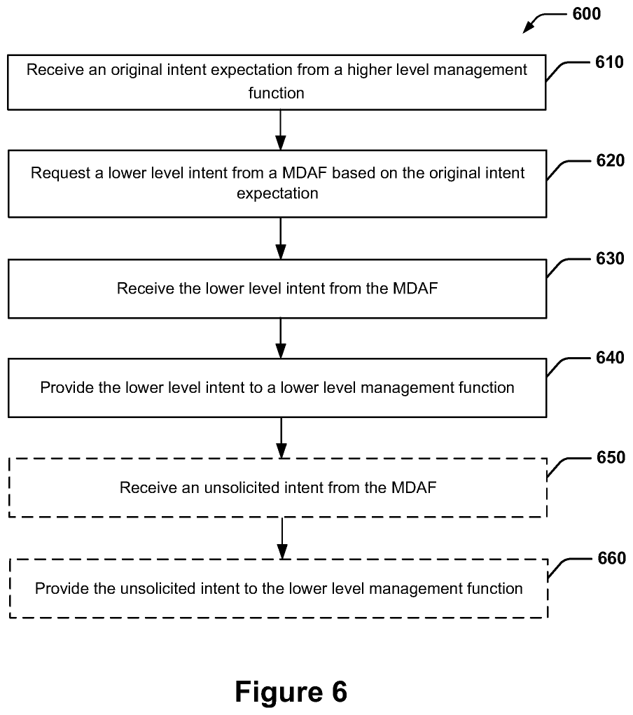

Turning now to FIGS. 1-7, examples are depicted with reference to one or more components and one or more methods that may perform the actions or operations described herein, where components and/or actions/operations in dashed line may be optional. Although the operations described below in FIGS. 5 and 6 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a diagram of an example of an architecture for management of a virtualized cellular network 100. The virtualized cellular network 100 may be implemented on a cloud network 105 to provide access for user equipment (UEs) 104. The virtualized cellular network 100 may include radio units 110, one or more edge datacenters 120, one or more datacenters 130, a network management system 140, and an MDAF 150.

The radio units 110 may include antennas configured to transmit and/or receive radio frequency (RF) signals. In some implementations, the radio units 110 may include RF processing circuitry. For example, the radio units 110 may be configured to convert the received RF signals to baseband samples and/or convert baseband samples to RF signals. The radio units 110 may be connected to the edge datacenter 120 via front-haul connections 116. The front-haul connections 116 may be wired connections such as fiber optic cables.

The edge datacenter 120 may include computing resources 122 and a switch 124, which may be connected to RUs 110 via the front-haul connections 116. The edge datacenter 120 may provide a virtualized base station for performing RAN processing for one or more cells. For example, the computing resources 122 may be hardware servers or virtual servers. The servers may be generic computing resources that can be configured to perform specific RAN protocol stacks including, for example, physical (PHY) layer, media access control (MAC) layer protocol stacks, radio link control (RLC) layer, and a radio resource control (RRC) layer. In some implementations, PHY layer processing may be more resource intensive than higher layer processing and may benefit from performance close to the RUs 110. The computing resources 122 may be connected to the switch 124 and to each other via connections, which may be wired connections such as Ethernet.

The datacenter 130 may include computing resources 132. Unlike the edge datacenter 120, the datacenter 130 may lack a direct connection to RUs 110. Generally, the datacenter 130 may be more centrally located, be connected to multiple other datacenters, and/or have greater computing resources 132 than an edge datacenter 120. In some implementations, higher layer network functions and/or core network functions may be performed at a datacenter 130. For example, the datacenter 130 may instantiate network functions such one or more Access and Mobility Management Functions (AMFs) 134, a Session Management Function (SMF) 136, and a User Plane Function (UPF) 138.

The network management system 140 may provide a network operator with tools for configuring the virtualized cellular network 100. In an aspect, the network management system 140 provides intent based configuration of the virtualized cellular network 100. An intent specifies the expectations including requirements, goals, and constraints for a specific service or network management workflow. An intent is typically understandable by humans, and also can be interpreted by a machine without any ambiguity. In contrast to an imperative configuration that specifies how a network or component is to perform, an intent expresses what a network should achieve. For example, an intent may express the metrics that are be achieved and not how to achieve the metrics.

In an aspect, the network management system 140 includes one or more network management functions 142. Each network management function 142 may receive an intent expectation and output one or more lower level intents or a configuration. For example, the network management function 142 may include an expectation interface 144 configured to receive an original intent expectation from a higher level management function. The network management function 142 may include an MDAF interface 146 configured to request a lower level intent from the MDAF 150 based on the original intent expectation. The network management function 142 may include an intent interface 148 configured to provide the lower level intent to a lower level network management function.

In some implementations, the network management functions 142 are slice based network management functions arranged in a hierarchical order. For instance, the network management functions 142 may include a communication service management function (CSMF), network slice management function (NSMF), a network slice subnet management function (NSSMF), or a network function management function (NFMF). The slice based network management functions may manage network constituents such as a slice, a slice subnet, or a network function (NF). Each management function 142 may provide an intent for a network constituent to a lower level network management function and/or to a NF. For example, the CSMF may provide an intent for one or more slices to the NSMF, which may provide an intent for one or more slice sub-nets to the NSSMF. The NSSMF may provide an intent for one or more NFs to the NFMF. The NFMF may instantiate the NFs on the network resources 122, 132 at the datacenters 120, 130 (possibly via an infrastructure service management system) and communicate with the active NFs.

In some implementations, the network management system 140 may be implemented on cloud resources such as a datacenter 130. In some implementations, the MDAF 150 may also be implemented on the cloud resources, and there may be a logical divide between the network management system 140 and the MDAF 150. In other implementations, the network management system 140 may be external to the cloud network 105 and may communicate with the MDAF 150 via a network connection.

The MDAF 150 may be configured to monitor a status of the computing resources 122, 132 and/or network functions deployed on the computing resources 122, 132. The MDAF 150 may collect metrics generated by the cloud network 105 (e.g., data rates, processor/memory utilization) and/or metrics generated by network functions (e.g., number of UEs, latency, throughput). In some implementations, the MDAF 150 may be associated with a level of network management functions. The MDAF 150 may collect network status information and/or metrics relevant to the associated level of network management functions. For instance, a network slice (NS) level MDAF may collect status information and/or metrics for network slices and a network slice sub-net (NSS) level MDAF may collect status information and/or metrics for slice sub-nets.

The MDAF 150 may include an intent generator component 160 configured to generate one or more lower level intents based on a received intent expectation. The intent generator component 160 may include a monitoring component 162 configured to receive information with respect to a performance of network resources or a status of the network. The intent generator component 160 may include a target component 164 configured to identify one or more target network constituents to satisfy the original intent expectation. The intent generator component 160 may include a translation component 166 configured to translate parameters of the original intent expectation to a scope of the target network constituent based on the information. The intent generator component 160 may include an intent interface configured to provide the lower layer intent to the network management function 142.

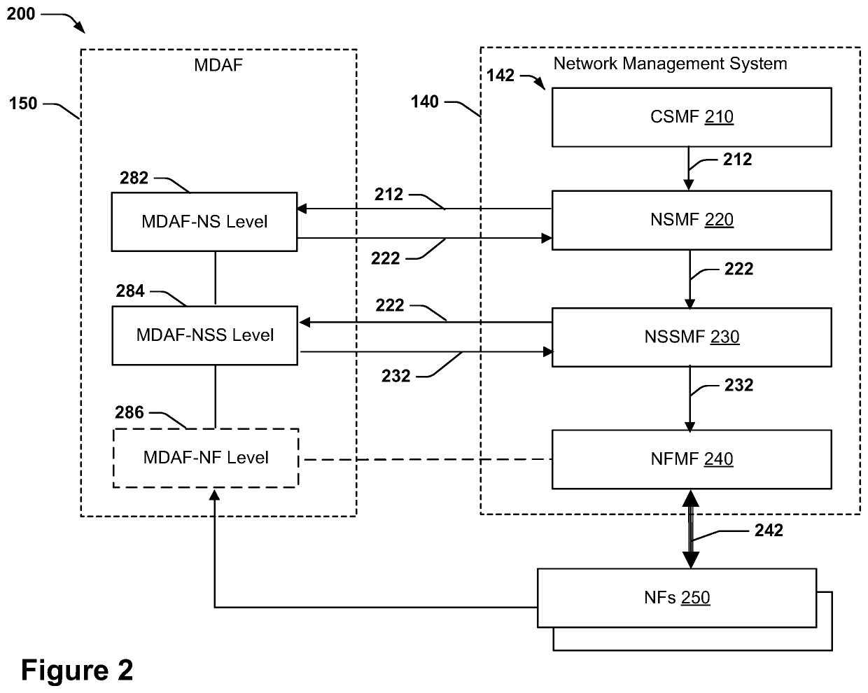

FIG. 2 is a diagram 200 of an example of network slice based management and analytics of a virtualized cellular network. The network management system 140 may include hierarchical management functions 142. For example, the management functions 142 may include a CSMF 210, a NSMF 220, a NSSMF 230, and a NFMF 240. Each management function 142 may be an intent based management function that receives an intent expectation from a higher level and generates an intent for a lower level and/or NFs 250. For example, the CSMF 210 may receive an intent (e.g., for a service) from a network operator and generate an intent expectation 212 for the NSMF 220. The NSMF may receive the intent expectation 212 as a new intent (e.g., for a network slice) and generate one or more intent expectations 222 for the NSSMF (e.g., intent expectations for various subnets). The NSSMF 230 may receive the intent expectation 222 as a new intent for a subnet and generate one or more intent expectations 232 for the NFMF 240 (e.g., intent defining required network functions). The NFMF 240 may receive the intent expectation 232 and generate configurations 242 for NFs 250. In some implementations, any of the NSMF 220, NSSMF 230, or NFMF 240 may include the MDAF interface 146 for using the MDAF 150 to generate an intent. For instance, the NFMF 240 may optionally use the MDAF 150 to generate an intent for an intent based infrastructure service management function. In other implementations, the NFMF may generate imperative configurations without using the MDAF 150.

In some implementations, MDAF 150 may operate at various levels corresponding to the hierarchical network management functions 142 (e.g., MDAF-NS level 282, MDAF-NSS level 284, and MDAF-NF level 286). For example, the MDAF 150 may include a separate component for each level that calculates metrics or performs analysis relevant to the level. The different levels may access a common pool of monitoring information such as measurements or data streams from the NFs 250 or underlying computing resources. In an aspect, one or more levels of the MDAF 150 may include the intent generator component 160 for generating an intent based on a performance of network resources or a status of the network. For example, the MDAF-NS level 282 may receive the intent expectation 212 for a network slice and generate one or more intents 222 for network slice sub-nets. As another example, the MDAF-NSS level 284 may receive the intent expectation 222 for a network slice sub-net and generate one or more intents 232 for network functions.

In some implementations, the MDAF 150 may generate unsolicited intents. For example, as the MDAF 150 is monitoring the network state, the MDAF 150 may determine that a lower level intent should be changed to satisfy a higher level intent expectation. For example, the MDAF 150 may determine that additional throughput at a UPF 138 is needed to satisfy an intent for the corresponding slice sub-net (e.g., based on an observed or predicted deficiency). The MDAF 150 may generate a new intent 232 for the network function (e.g., UPF 138) and provide the new intent to the NSSMF 230. In some implementations, the NSSMF 230 may determine whether to provide the unsolicited intent to a lower layer management function (e.g., NFMF 240).

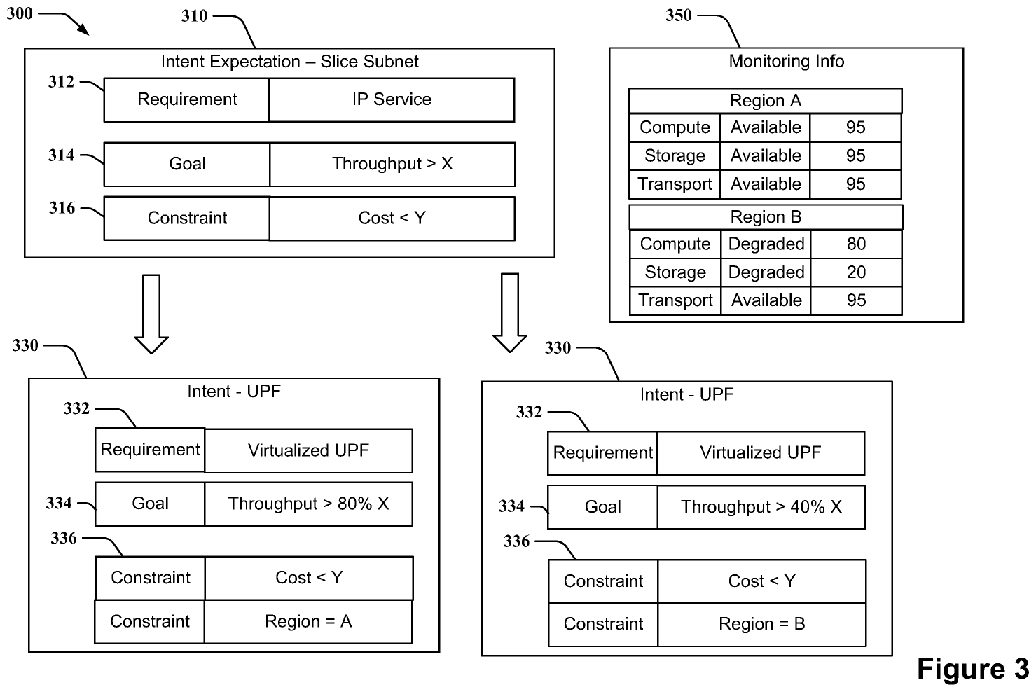

FIG. 3 is a diagram 300 illustrating generation of a lower level intent to satisfy a higher level intent expectation based on network analytics. For example, the MDAF 150 may receive an intent expectation 310 for a slice subnet with a requirement 312 to provide an IP service with a goal 314 of a throughput greater than X and a constraint of a cost less than Y. The MDAF 150 may generate one or more intents 330 for network functions to satisfy the intent expectation 310.

In an aspect, the MDAF 150 may collect information with respect to a performance of network resources or a status of the network. For example, the MDAF 150 may receive monitoring information 350. In some implementations, the monitoring information 350 may include performance or status information regarding compute resources, storage resources, or transport resources in the network 105. For instance, the monitoring information 350 may indicate a status such as available, degraded, or unavailable for each type of resource in one or more regions or at specific datacenters. The performance information may specify one or more relevant performance metrics such as compute CPU utilization, storage capacity, or transport bandwidth. The MDAF 150 may also collect information regarding the status or performance of network constituents such as NFs 250, network slice subnets, or network slices.

To satisfy a higher level intent, the MDAF 150, intent generator component 160, or target component 164 may identify one or more target network constituents to satisfy the original intent. For example, the target network constituents may be the network constituent corresponding to the level below the higher level intent. For instance, the target network constituents for intent expectation 310 for a slice subnet may be network functions. In some implementations, the higher level intent may specify at least some network constituents to satisfy the intent. The MDAF 150 may also be configured with or learn rules to identify target network constituents. For example, the MDAF 150 may be configured with a rule that a UPF is needed to provide IP service or satisfy a throughput goal. As another example, the MDAF 150 may analyze monitoring information 350 to determine network constituents that contribute to performance under certain conditions. For example, some configurations of the AMF may limit performance of the UPF, so the AMF may also be a target constituent to satisfy the intent expectation 310. In another example, the size of a control plane element may be based on the expected transactions per second (TPS) implied by an input parameter. For instance, the MDAF 150 may identify a control plane element such as a SMF 136 based on a goal for transactions, subscribers, or busy hours.

The MDAF 150, intent generator component 160, or translation component 166 may translate parameters of the intent expectation 310 to a scope of the target network constituent (e.g., UPF) based on the monitoring information 350. For example, the translation component 166 may set a performance target for the target network constituent based on the parameters of the intent expectation 310. For instance, the translation component 166 may determine a throughput of each of a plurality of UPFs to satisfy the throughput of the slice subnet. The translation component 166 may then estimate a parameter (e.g., requirements 332, goals 334, or constraints 336) within the scope of the target network constituent to achieve the performance target based on the monitoring information 350. For instance, the translation component 166 may determine a throughput goal 334 for each UPF based on the monitoring information 350. The throughput goal 334 for a UPF in region A may be higher than a throughput goal for a UPF in region B due to the degraded performance in region B. As another example, for the SMF 136, the translation component 166 may translate a supported number of sessions per busy hour to a specific SMF sizing based on a derived model of transactions, subscribers, and hours.

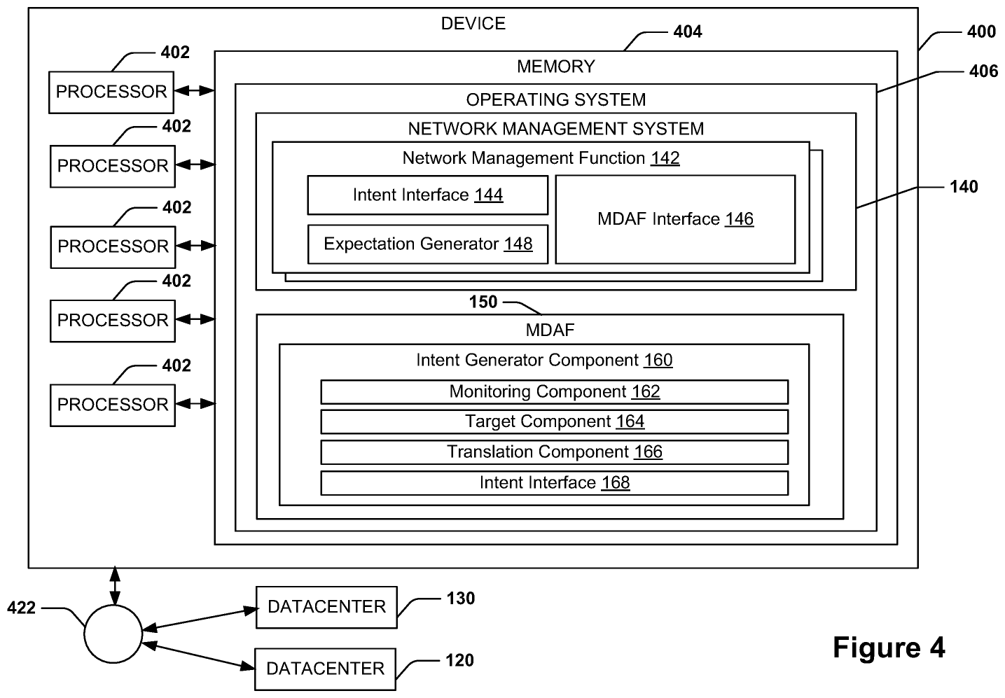

FIG. 4 is a schematic diagram of an example of a device 400 (e.g., a computing device) for network configuration. The device 400 may be an example of a computing resource 132 such as a server at a datacenter 130 that hosts the network management system 140 and/or the MDAF 150. The device 400 is connected to other servers within the datacenter via a switch 422 and may be connected to servers at other datacenters.

In an example, device 400 can include one or more processors 402 and/or memory 404 configured to execute or store instructions or other parameters related to providing an operating system 406, which can execute one or more applications or processes, such as, but not limited to, at least one of a network management function 142 or an MDAF 150 including an intent generator component 160. For example, processor 402 and memory 404 may be separate components communicatively coupled by a bus (e.g., on a motherboard or other portion of a computing device, on an integrated circuit, such as a system on a chip (SoC), etc.), components integrated within one another (e.g., processor 402 can include the memory 404 as an on-board component), and/or the like. Memory 404 may store instructions, parameters, data structures, etc. for use/execution by processor 402 to perform functions described herein.

In an example, the network management system 140 may optionally include one or more network management functions 142 (e.g., CSMF 210, NSMF 220, NSSMF 230, or NFMF 240), each network management function 142 including an expectation interface 144, an MDAF interface 146, and an intent interface 148.

In an example, the MDAF 150 may include an intent generator component 160 that includes one or more of the monitoring component 162, the target component 164, the translation component 166, or the intent interface 168.

FIG. 5 is a flow diagram of an example of a method 500 for intent-based network configuration based on network analytics. For example, the method 500 can be performed by a device 400 and/or one or more components thereof to use an analytics function to instantiate one or more network functions 250 within a cloud network 105 to provide a network service. For instance, the method 500 may be performed by a device implementing the MDAF 150 including the intent generator component 160. In some implementations, the method 500 may be performed in conjunction with the method 600 (FIG. 6) performed by a network management function 142.

At block 510, the method 500 may include receiving a request for a lower level intent based on an original intent expectation from a network management function. In an example, the MDAF 150 and/or intent interface 168, e.g., in conjunction with processor 402, memory 404, and operating system 406, can receive a request for a lower level intent 330 based on an original intent expectation 310 from a network management function 142.

At block 520, the method 500 may include receiving information with respect to a performance of network resources or a status of the network. In an example, the MDAF 150 and/or monitoring component 162, e.g., in conjunction with processor 402, memory 404, and operating system 406, can receive information 350 with respect to a performance of network resources 122, 132 or a status of the network 105.

At block 530, the method 500 includes identifying one or more target network constituents to satisfy the original intent. In an example, the MDAF 150 and/or target component 164, e.g., in conjunction with processor 402, memory 404, and operating system 406, can identify one or more target network constituents (e.g., network functions 250) to satisfy the original intent expectation 310. In some implementations, at block 532 the block 530 may optionally include identifying network constituents implied by parameters of the original intent. For example, the target component 164 may map requirements 312, goals 314, or constraints 316 to network constituents based on configured or learned rules. For instance, the rules may identify network constituents that causally contribute to performance metrics that may be included as parameters of an intent.

At block 540, the method 500 includes translating parameters of the original intent expectation to a scope of the target network constituent based on the information. In an example, the MDAF 150 and/or the translation component 166, e.g., in conjunction with processor 402, memory 404, and operating system 406, can translate parameters (e.g., requirements 312, goals 314, or constraints 316) of the original intent expectation 310 to a scope of the target network constituent (e.g., UPF 132) based on the information 350. In some implementations, at block 542 the block 540 may optionally include setting a performance target for the target network constituent based on the parameters. For example, the translation component 166 may select a performance metric for the target network constituent that will satisfy the parameter of the intent expectation as the performance target. In some implementations, at block 544 the block 540 may optionally include estimating a parameter within the scope of the target network constituent to achieve the performance target based on the information 350. For instance, a throughput performance target may be affected by the performance of compute resources and transport resources, so the translation component may estimate the amount of compute resources and transport resources to satisfy the intent based on current performance information for the resources.

At block 550, the method 500 includes providing one or more lower level intents to the network management function. In an example, the MDAF 150 and/or the intent interface 168, e.g., in conjunction with processor 402, memory 404, and operating system 406, can provide one or more lower level intents 330 to the network management function 142.

At block 560, the method 500 optionally includes monitoring performance of the one or more target network constituents with respect to the lower level intent and the original intent expectation. In an example, the MDAF 150 and/or the monitoring component 162, e.g., in conjunction with processor 402, memory 404, and operating system 406, can monitor performance of the one or more target network constituents with respect to the lower level intent and the original intent expectation. For example, the monitoring component 162 may collect additional monitoring information 350 such as performance metrics of the one or more target network constituents.

At block 570, the method 500 optionally includes updating the lower level intent based on the performance. In an example, the MDAF 150 and/or the translation component 166, e.g., in conjunction with processor 402, memory 404, and operating system 406, can update the lower level intent 330 based on the performance. For example, the translation component 166 may recalculate the estimated parameters within the scope of the target network constituent to achieve the performance target based on the actual performance information.

FIG. 6 is a flow diagram of a method 600 for utilizing a MDAF for generating lower level intents. For example, the method 600 can be performed by a network management function 142 in conjunction with an MDAF 150 performing the method 500. The method 600 can be performed by the device 400 and/or one or more components thereof (e.g., the network management function 142) to provide lower level intents 330 to a lower level network management function.

At block 610, the method 600 may include receiving an original intent expectation from a higher level management function. In an example, the network management function 142 (e.g., NSMF 220) and/or the expectation interface 144, e.g., in conjunction with processor 402, memory 404, and operating system 406, can receive an original intent expectation 212 from a higher level management function (e.g., CSMF 210).

At block 620, the method 600 may include requesting a lower level intent from a MDAF based on the original intent expectation. In an example, the network management function 142 (e.g., NSMF 220) and/or the MDAF interface 146, e.g., in conjunction with processor 402, memory 404, and operating system 406, can request the lower level intent 330 from a MDAF 150 based on the original intent expectation 212.

At block 630, the method 600 may include receiving the lower level intent from the MDAF. In an example, the network management function 142 (e.g., NSMF 220) and/or the MDAF interface 146, e.g., in conjunction with processor 402, memory 404, and operating system 406, can receive the lower level intent 330 from the MDAF 150.

At block 640, the method 600 may include providing the lower level intent to a lower level management function. In an example, the network management function 142 (e.g., NSMF 220) and/or the intent interface 148, e.g., in conjunction with processor 402, memory 404, and operating system 406, can provide the lower level intent 222 to a lower level management function (e.g., NSSMF 230).

At block 650, the method 600 may optionally include receiving an unsolicited intent from the MDAF. In an example, the network management function 142 (e.g., NSMF 220) and/or the MDAF interface 146, e.g., in conjunction with processor 402, memory 404, and operating system 406, can receive an unsolicited intent from the MDAF 150.

At block 660, the method 600 may optionally include providing the unsolicited intent to the lower level management function. In an example, the network management function 142 (e.g., NSMF 220) and/or the intent interface 148, e.g., in conjunction with processor 402, memory 404, and operating system 406, can provide the unsolicited intent to the lower level management function (e.g., NSSMF 230).

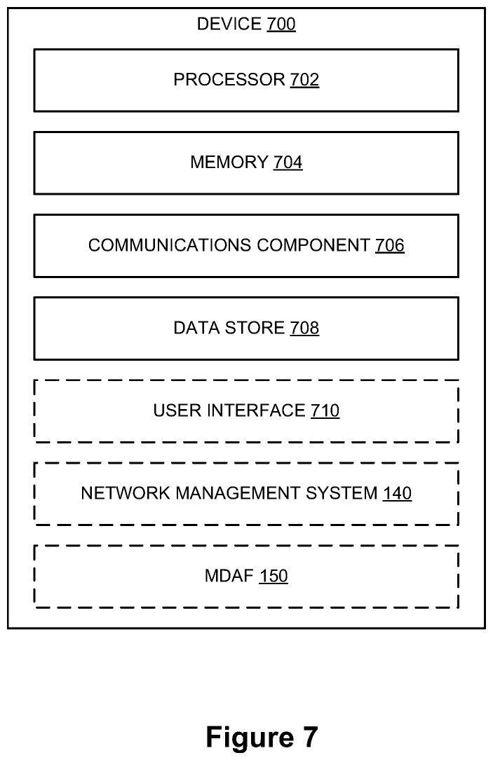

FIG. 7 illustrates an example of a device 700 including additional optional component details as those shown in FIG. 4. In one aspect, device 700 may include processor 702, which may be similar to processor 402 for carrying out processing functions associated with one or more of components and functions described herein. Processor 702 can include a single or multiple set of processors or multi-core processors. Moreover, processor 702 can be implemented as an integrated processing system and/or a distributed processing system.

Device 700 may further include memory 704, which may be similar to memory 404 such as for storing local versions of operating systems (or components thereof) and/or applications being executed by processor 702, such as the network management system 140, the MDAF 150, etc. Memory 704 can include a type of memory usable by a computer, such as random access memory (RAM), read only memory (ROM), tapes, magnetic discs, optical discs, volatile memory, non-volatile memory, and any combination thereof.

Further, device 700 may include a communications component 706 that provides for establishing and maintaining communications with one or more other devices, parties, entities, etc. utilizing hardware, software, and services as described herein. Communications component 706 may carry communications between components on device 700, as well as between device 700 and external devices, such as devices located across a communications network and/or devices serially or locally connected to device 700. For example, communications component 706 may include one or more buses, and may further include transmit chain components and receive chain components associated with a wireless or wired transmitter and receiver, respectively, operable for interfacing with external devices.

Additionally, device 700 may include a data store 708, which can be any suitable combination of hardware and/or software, that provides for mass storage of information, databases, and programs employed in connection with aspects described herein. For example, data store 708 may be or may include a data repository for operating systems (or components thereof), applications, related parameters, etc.) not currently being executed by processor 702. In addition, data store 708 may be a data repository for network management system 140, MDAF 150, etc.

Device 700 may optionally include a user interface component 710 operable to receive inputs from a user of device 700 and further operable to generate outputs for presentation to the user. User interface component 710 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 710 may include one or more output devices, including but not limited to a display, a speaker, a haptic feedback mechanism, a printer, any other mechanism capable of presenting an output to a user, or any combination thereof.

Device 700 may additionally include a network management system 140 for coordinating generation of lower-level intents based on an intent expectation, an MDAF 150 for generating the lower-level intents based on the intent expectation, etc., as described herein.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Non-transitory computer-readable media excludes transitory signals. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the claim language. Reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A system of intent based network slice management, comprising:
a network management function configured to:
receive an original intent expectation from a higher level management function;
request a lower level intent from a management data analytics function (MDAF) based on the original intent expectation; and
provide the lower level intent to a lower level management function; and
the MDAF, which is configured to:
collect information with respect to a performance of network resources or a status of the network;
identify one or more target network constituents to satisfy the original intent expectation;
translate parameters of the original intent expectation to a scope of the target network constituent based on the information; and
provide the lower level intent to the network management function.

2. The system of claim 1, wherein the MDAF is configured to monitor performance of the one or more target network constituents with respect to the lower level intent and the original intent expectation.

3. The system of claim 2, wherein the MDAF is configured to update the lower level intent based on the performance.

4. The system of claim 1, wherein the network management function is further configured to:
receive an unsolicited intent from the MDAF; and
provide the unsolicited intent to the lower level management function.

5. The system of claim 1, wherein the information with respect to performance of network resources or the status of the network comprises a metric or status of one or more of computing resources, storage resources, or transport resources.

6. The system of claim 1, wherein to identify the one or more target network constituents to satisfy the original intent, the MDAF is configured to identify network implied by parameters of the original intent.

7. The system of claim 1, wherein to translate parameters of the original intent expectation to a scope of the target network constituent based on the information, the MDAF is configured to:
set a performance target for the target network constituent based on the parameters; and
estimate a parameter within the scope of the target network constituent to achieve the performance target based on the information.

8. A method of generating an intent based on network analytics, comprising:
receiving, at a management data analytics function (MDAF), a request for a lower level intent based on an original intent expectation from a network management function;
receiving information with respect to a performance of network resources or a status of the network;
identifying one or more target network constituents to satisfy the original intent; and
translating parameters of the original intent expectation to a scope of the target network constituent based on the information.

9. The method of claim 8, further comprising monitoring performance of the one or more target network constituents with respect to the lower level intent and the original intent expectation.

10. The method of claim 9, further comprising updating the lower level intent based on the performance.

11. The method of claim 8, wherein the information with respect to performance of network resources or the status of the network comprises a metric or status of one or more of computing resources, storage resources, or transport resources.

12. The method of claim 8, wherein identifying one or more target network constituents to satisfy the original intent comprises identify network constituents associated with parameters of the original intent.

13. The method of claim 8, wherein translating parameters of the original intent expectation to a scope of the target network constituent based on the information, comprises:
setting a performance target for the target network function based on the parameters; and
estimating a parameter within the scope of the target network constituent to achieve the performance target based on the information.

14. The method of claim 8, further comprising, at a network management function:
receiving an original intent expectation from a higher level management function;
requesting the lower level intent from the MDAF based on the original intent expectation; and
providing the lower level intent to a lower level management function.

15. The method of claim 14, further comprising:
receiving an unsolicited intent from the MDAF; and
providing the unsolicited intent to the lower level management function.

16. A non-transitory computer-readable medium storing computer executable instructions for intent based network slice management, comprising instructions to:
receive, at a management data analytics function (MDAF), a request for a lower level intent based on an original intent expectation from a network management function;
receive information with respect to a performance of network resources or a status of the network;
identify one or more target network constituents to satisfy the original intent; and
translate parameters of the original intent expectation to a scope of the target network constituent based on the information.

17. The non-transitory computer-readable medium of claim 16, further comprising instructions to:
monitor performance of the one or more target network constituents with respect to the lower level intent and the original intent expectation; and
update the lower level intent based on the performance.

18. The non-transitory computer-readable medium of claim 16, wherein the information with respect to performance of network resources or the status of the network comprises a metric or status of one or more of computing resources, storage resources, or transport resources.

19. The non-transitory computer-readable medium of claim 16, wherein the instructions to identify one or more target network constituents to satisfy the original intent comprises instructions to identify network constituents associated with parameters of the original intent.

20. The non-transitory computer-readable medium of claim 16, wherein the instructions to translate parameters of the original intent expectation to a scope of the target network constituent based on the information, comprises instructions to:
set a performance target for the target network function based on the parameters; and
estimate a parameter within the scope of the target network constituent to achieve the performance target based on the information.
